(19) United States
(12) Patent Application Publication
(10) Pub. No.: US 2009/0025388 A1
(43) Pub. Date: Jan. 29, 2009

(54) METHOD AND SYSTEM FOR GENERATION OF POWER USING STIRLING ENGINE PRINCIPLES

(76) Inventors: Guy Silver, Sunnyvale, CA (US); Juinerong Wu, Sunnyvale, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/577,167

(22) PCT Filed: Oct. 7, 2005
(86) PCT No.: PCT/US05/36206

§ 371 Date: Apr. 12, 2007

Related U.S. Application Data
(63) Continuation-in-part of application No. 10/963,274, filed on Oct. 12, 2004.

(30) Foreign Application Priority Data
Feb. 9, 2005 (US) 11054057

(51) Int. Cl. F02G 1/043; F01K 3/00; F01K 25/00

(52) U.S. Cl. 60/659; 60/650; 60/682

(57) ABSTRACT

A heat engine enclosing a chamber in housing has two zones maintained at different temperatures. The first zone receives heat energy from an external power source. The second zone is connected to the hot zone by two conduits, such that a fluid (e.g., air, water, or any other gas or liquid) filling the chamber can circulate between the two zones. The expansion of the fluid in the hot zone and the compression of the fluid in the cold zone drive the rotation of the housing to provide a power output. The fluid may be pressurized to enhance efficiency. A cooling fluid provided in a stationary reservoir maintains a preferred operating temperature difference between the hot zone and the cold zone. A heat storage structure containing a fluid with a high heat capacity may be provided as a heat reservoir.

### CROSS REFERENCE TO RELATED APPLICATIONS

The present application is a continuation-in-part application of, and claims priority to, co-pending U.S. patent application Ser. No. 10/963,274, entitled “Method and System for Generation of Electrical and Mechanical Power using Stirling Engine Principles,” filed on Oct. 12, 2004, bearing Attorney Docket No. M-15504 US. The Co-pending patent application is hereby incorporated by reference in its entirety.

### BACKGROUND OF THE INVENTION

1. Field of the Invention

The present invention relates to applying Stirling engine principles to power conversion equipment design and use. In particular, the present invention relates to applying Stirling engine principles for power generation, such as generating mechanical power.

2. Discussion of the Related Art

The Stirling engine is a heat engine that operates by converting the heat energy which flows between zones of different temperatures into useful work. A typical Stirling engine uses the heat energy to drive a coordinated and reciprocating motion of a set of pistons. The motion of the pistons drives machinery or a generator. Alternatively, heat engines having rotary motion are also known. Numerous designs of Stirling engines having rotary motion can be found in the prior art, including: U.S. Pat. Nos. 6,195,992, 3,984,981, and 5,325,671.

In the prior art, moving parts for the Stirling engine operation are enclosed in a housing and coupled mechanically (e.g., by an axle) to external parts to drive external machinery. High efficiency in such an arrangement requires that the housing be sealed in an airtight fashion. A seal failure leads to the failure of the engine.

### SUMMARY

The present invention provides a method and a rotary engine based on Stirling engine principles. According to one embodiment of the present invention, the housing of the rotary engine rotates as a result of fluid flow between two zones of different temperatures within a chamber in the housing. The torque in the rotary motion of the housing, therefore, may be used to drive machinery (e.g., a generator) through an axle or a gear structure coupled externally to the housing. Under this arrangement, unlike the prior art, a rotary engine of the present invention is not susceptible to failure due to a leak in the sealing of the housing.

According to one embodiment of the present invention, the hot zone of the chamber is heated by energy from a heat source, and a cooling system maintains the cold zone at a lower temperature than the hot zone. The cooling fluid may be drawn from a stationary external reservoir of cooling fluid. In one embodiment, the rotary motion of the housing may be used to draw the cooling fluid. In that embodiment, the volume of cooling fluid drawn into the rotary engine depends on the angular speed of the rotary motion which, in turn, may be determined by power output of the rotary engine. A self-regulating cooling system may therefore be achieved. A structure used to reinforce the housing at the point where the external axle (or the external gear structure) is to be attached may include a threaded passage. In that embodiment, the rotating threaded passage forces the cooling fluid into the housing, through passages distributed around the cold zone (e.g., the insulation layer abutting the cold zone, the fluid guide structure or the area between the cold zone and the housing) so as to maintain the cold zone to within a desired temperature range.

A turbine in a heat engine according to the present invention may be located in any suitable location on the interior surface of the housing hot zone or the cold zone, but is coupled to the housing to provide the housing rotary motion and is not required to directly drive an axle or a gear structure to provide the output power of the rotary engine. The chamber of the rotary engine may be filled with a compressible working fluid (e.g., air). Fluid guides may be provided within the chamber for guiding the flow of the compressible working fluid in preferred directions and flow velocities to provide higher efficiency. The fluid guides may also provide structural or mechanical support for the chamber. Thus the heat engine design provides a method for adjusting working fluid temperature inside housing 101, by running fluid from a cooling source or a heating source through fluid guides to the hot zone, the cold zone or both. This also provides methods to adjust power output of the engine without changing heat source or heat sink.

In one embodiment, a one-way valve may be provided between the hot zone and the cold zone prevents a working fluid in the hot zone to backflow into the cold zone.

In another embodiment, a metal mesh is provided in the hot zone to increase efficiency of heat transfer from the heat source to the hot zone. A heat storage structure can also be provided to minimize the impact of a fluctuating heat source on the power output of the rotary engine during engine cycles or to provide a secondary heat source for the heat engine. A high specific heat capacity fluid or a heat storage fluid can be used in the heat storage structure. Heat storage may be used to equalize the energy production or output requirements during times of different energy demand.

In one embodiment, a conductive plate is urged by springs loaded to contact the hot zone after predetermined operation conditions (e.g., a predetermined temperature) are reached.

The present invention is better understood upon consideration of the detailed description below and the accompanying drawings.

### BRIEF DESCRIPTION OF THE DRAWINGS

FIG. 1 shows a cross section view of heat engine 100 with cooling reservoir 107, in accordance with one embodiment of the present invention.

FIG. 2 shows heat engine 100 with cooling reservoir 107 in an isometric exploded side view.

FIG. 3 shows heat engine 100 in a “blown-up” perspective view.

FIG. 4 is a top view of hot zone 110a underneath top plate 101a.

FIG. 5 shows rotary structure 111 of FIGS. 1 and 2 in greater detail.

FIG. 6 is a top view showing spiral passages 601 and 602 in the portion of insulator layer 104 abutting cold zone 110b.

FIG. 7 shows a cross section view of heat reservoir 701, in accordance with one embodiment of the present invention.

FIG. 8 is a cross section view showing the working fluid circulation paths in the interior of housing 101.

To facilitate cross-reference among the figures and to simplify the detailed description below, like elements in the figures are assigned like reference numerals.

### DETAILED DESCRIPTION OF THE PREFERRED EMBODIMENTS

The present invention provides a heat engine that operates under Stirling engine principles to convert heat energy from a heat source into mechanical energy. The mechanical energy can be coupled to drive machinery and generators to perform useful work. Examples of a suitable heat source include solar, geothermal, fossil, landfill, recovered or other fuels.

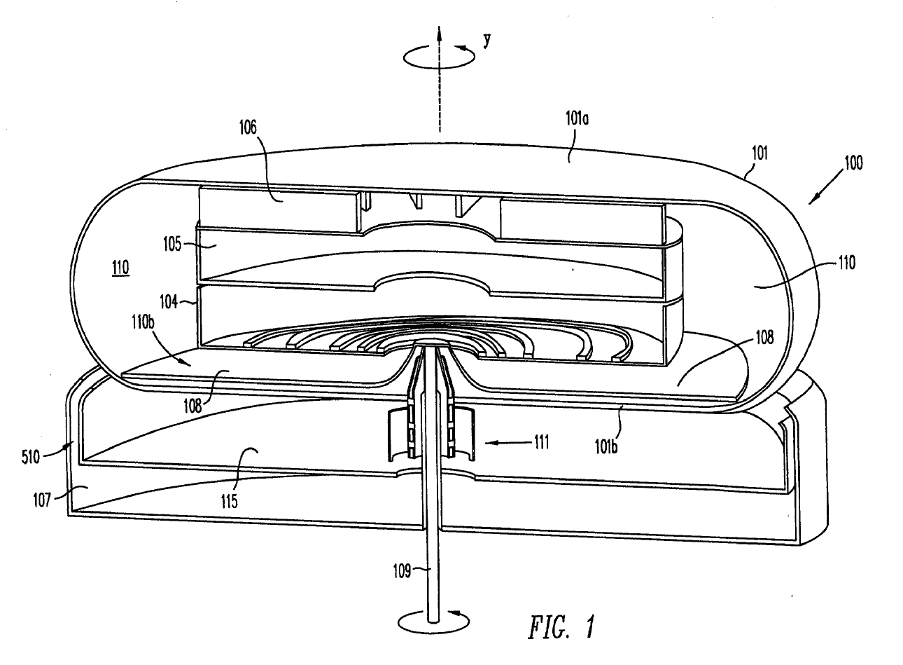

FIG. 1 shows a cross section view of heat engine 100, including cooling fluid reservoir 107, according to one embodiment of the present invention. As shown in FIG. 1, heat engine 100 includes a chamber 110 enclosed in an enclosure or housing 101. During operation, when a heat source is provided incident on top surface 101a of housing 101, a temperature difference exists between a “hot zone” 110a and a “cold zone” 110b within chamber 110. The present invention exploits this temperature difference to cause housing 101 to rotate about the axis indicated by “Y” in a manner described below. Because the engine housing rotates during operation and because the working fluid space is enclosed in the chamber with no passage, hole or junction between the chamber and the rotary power output device, so that the engine working fluid is isolated from the outside power generation gears or mechanical devices. Therefore, no special sealing is required.

The rotary motion turns axle 109, which may be used to drive the motion of an external mechanical device. As shown in FIG. 1, axle 109 is substantially perpendicular to the cross section area or plane between hot zone 110a and cold zone 110b. Using other suitable structures, rotary power output can also be achieved (e.g., a gear structure; such a structure may be located anywhere outside housing 101 or build into the exterior wall of housing 101). According to one embodiment of the present invention, axle 109 is partly ensheathed in rotary structure 111 and extends beyond cooling reservoir 107. Axle 109 is coupled with rotary structure 111 in rotational motion. Alternatively, axle 109 may also be connected to top plate 101a of housing 101. Thus the heat engine design provides a method for adjusting working fluid temperature inside housing 101, by running fluid from a cooling source or a heating source through fluid guides to the hot zone, the cold zone or both. This also provides methods to adjust power output of the engine without changing heat source or heat sink.

In the embodiment shown in FIG. 1, a cooling mechanism is provided to maintain the temperature difference between hot zone 110a and cold zone 110b. This temperature difference drives the rotary motion of housing 101, thus providing output power. The cooling mechanism includes cooling reservoir 107 containing a cooling fluid, which is circulated between cooling reservoir 107, cold zone 110b, space 508 and insulator layer 104 to maintain or to increase the temperature difference between cold zone 110b and hot zone 110a. A reservoir cover 115 is provided between housing 101 and cooling reservoir 107 to prevent spilling and excessive evaporation of the cooling fluid. In this detailed description, the terms “hot” and “cold” are relative. Heat engine 100 will operate as long as there is a sufficient temperature difference between the hot zone 110a and the cold zone 110b.

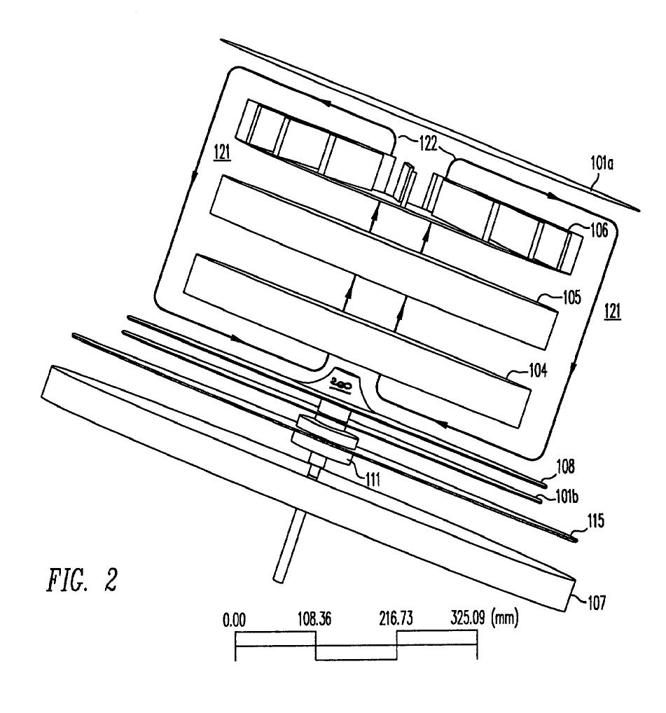

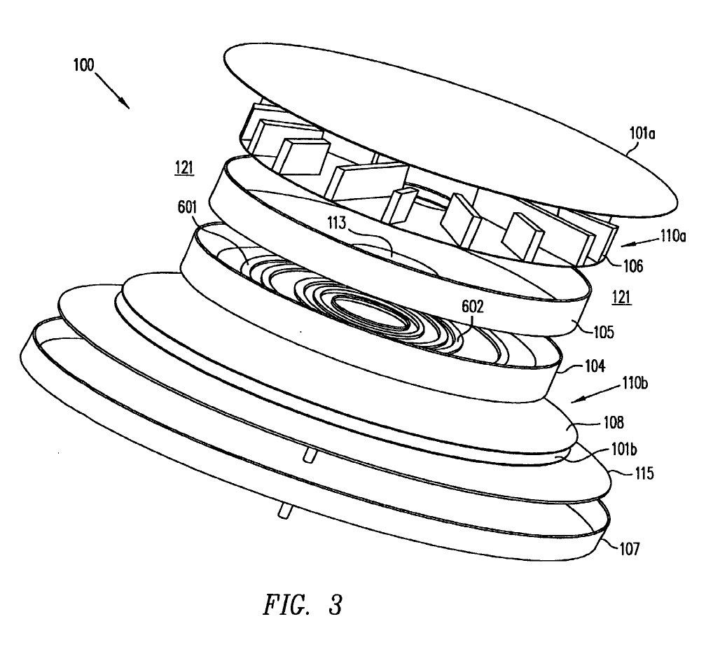

The elements enclosed within housing 101 is better illustrated in conjunction with FIGS. 2 and 3 which show, respectively, heat engine 100 in a “isometric exploded” side view and an “isometric exploded” perspective view. The outer side wall of housing 101 is omitted in FIGS. 2 and 3, so as to allow the internal construction of heat engine 100 within chamber 110 to be shown. As shown in FIGS. 1, 2 and 3, top plate 101a and bottom plate 101b are, respectively, the top outer wall and the bottom outer wall of housing 101. In this embodiment, a heat source (e.g., solar energy) is incident on top plate 101a. As described below, the cooling fluid of cooling reservoir 107 maintains the region between insulator layer 104 and bottom plate 101b to a lower temperature. The combined action of the heat source and the cooling fluid creates hot zone 110a and cold zone 110b, as indicated in FIGS. 1, 2 and 3. In this embodiment, the cold zone 110b is separated from bottom plate 101b by a disk 108, to create a space 508 between disk 108 and bottom plate 101b in which the cooling fluid may flow, so as to achieve temperature regulation. (In this description, the upper and lower portions of FIG. 2 are labeled “top” and “bottom”, respectively, merely to facilitate reference in this detailed description. The operation of a heat engine of the present invention is not limited by its physical orientation.) In FIGS. 2 and 3, heat engine 100 is shown in “exploded” views in the sense that the separations between elements of heat engine 100 are exaggerated in the vertical direction for illustration purpose. In one embodiment, disk 108 is provided adjacent the bottom plate of housing 101, thereby, separating cold zone 110b from bottom plate 101b. Bottom plate 101b surrounds disk 108, creating a space 508 in which the cooling fluid may flow, so as to achieve temperature regulation. Disk 108 can be seen as the bottom of housing 101, and bottom plate 101b can be seen as a surrounding enclosure around the bottom of housing 101 such that space 508 is formed.

Hot zone 110a and cold zone 110b are insulated from each other by insulator layer 104, which is described in further detail below. Suitably placed support structures may be provided throughout hot zone 110a and cold zone 110b for mechanical support inside housing 101. Such support structures may include, for example, posts, stakes, beams and poles. Thermionic and thermocouple devices may be provided within insulator layer 104 as well. Such devices may be used to provide power output, as discussed in the Co-pending patent application incorporated by reference above. In this embodiment, a separator structure 105 is further interposed between hot zone 110a and insulator layer 104. Fluid flows between hot zone 110a and cold zone 110b through central open shaft 113 and space 121. Space 121 includes all space between fluid guide structure 106, separator structure 105, insulator layer 104, rotary structure 111, and outer wall of housing 101. Separator structure 105 is an optional storage structure, which is described in further detail below.

Chamber 110 is filled with a compressible working fluid, which may be air, another fluid or a mixture of fluids to achieve s desired fluid density, and mechanical, aerodynamic and thermal properties. The working fluid may be pressurized.

Heat engine 100 harvests the heat energy received by a turbine structure which may be located on the surface of the interior wall of housing 101. Such a location may include, for example, within space 121, hot zone 110a and cold zone 110b. A turbine structure may also be located on the surface of internal structures between hot zone 110a and cold zone 110b. Such a location may include, for example, within space 121 and within central open shaft 113. A turbine structure may be located at any suitable location where a torque can be generated for the desired rotary motion of housing 101. The turbine structure may also be built into the interior wall of housing 101. These turbine structures may include one or more sets of fluid guides or blades, which are designed to guide the working fluid, to control the working fluid velocity and pressure, and to create the torque for the rotary motion, so as to extract the maximum surging power from the expansion and the compression of the working fluid. In one embodiment, each fluid guide of the turbine structure preferably maintains a predetermined angle relative to the working fluid during rotation of housing 101. The turbine structure may be any suitable size or materials, depending on the application of the heat engine 100.

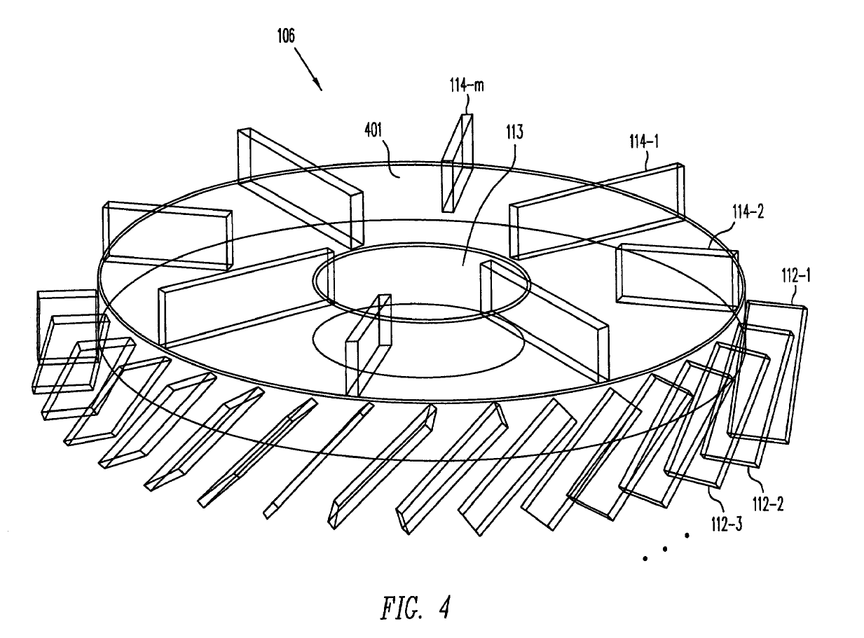

According to one embodiment of the present invention, heat engine 100 includes a turbine structure, referred herein as fluid guide structure 106, in hot zone 110a. FIG. 4 is a top view of hot zone 110a underneath top plate 101a. As shown in FIG. 4, heat engine 100 includes fluid guide structure 106, which includes plate 401, a first set of fluid guides 114 numbering from 114-1 to 114-m and a second set of fluid guides 112 numbering from 112-1 to 112-n, where n and m are integers. Plate 401 can be a top plate of separator structure 105 or insulator layer 104, depending on the configuration of heat engine 100. Fluid guides 112 and 114 may be designed to work cooperatively or separately, and may function as extra thermal transfer surfaces as a heat source or heat sink. Fluid guides 112 and 114 may be any suitable size, curvature or made of any material, depending on the application of the heat engine 100. In general, fluid guides 112-1 to 112-n may be attached to any structure between hot zone 110a and cold zone 110b (within space 121 and central open shaft 113). Fluid guides 112-1 to 112-n may also be attached to the interior wall of housing 101. In one embodiment, fluid guides 112-1 to 112-n are attached to housing 101 and are generally arranged around the periphery of plate 401 in space 121 as shown in FIG. 4. Fluid guides 112 may also be attached to plate 401, to fluid guide structure 106, to separator structure 105 or to insulator layer 104. Fluid guides 112 may have an aerodynamic design. In an aerodynamic design, a pressure difference is created between two surfaces of the fluid guide, as the fluid flows at different velocities along the surfaces. In one embodiment, each fluid guide is provided a rounded contour, such that one side of the fluid guide may have a larger cross-section than the other, thereby creating a torque that provides the rotary motion of housing 101.

As discussed above, fluid guides 112-1 to 112-n are designed to maintain a predetermined angle relative to the working fluid flow direction in the immediate vicinity of each of fluid guides 112. During operation, as heat builds up in hot zone 110a, the expanding working fluid in hot zone 110a pushes against fluid guide set 112 to create a torque to cause housing 101 to rotate. The working fluid in hot zone 110a flows radially outwards from space above central open shaft 113, and into cold zone 110b through annular space 121. Alternatively, fluid guides 112 may be attached to structures within central open shaft 113, for example, cooling system passages to insulator layer 104, insulator layer 104, separator structure 105, one-way valve 801 and fluid guide structure 106.

One example of using fluid guides 112 of fluid guide structure 106 with an axle to form a turbine is disclosed in the Co-pending patent application incorporated by reference above. The torque created by the rotating fluid guide structure 106 is transmitted to the rotary structure 111 (and thus axle 109) through the outer wall of housing 101, such that housing 101 rotates integrally with fluid guide structure 106. The asymmetrical surface areas on each of fluid guides 112 are not necessary, but may provide some advantage in some application, such as ease in starting up with motion in a predetermined direction. Fluid guides 112 may provide a large surface area for heat transfer. Thus, heat engine 100 has a high surface to volume ratio to enhance efficiency. Fluid guides 112-1 to 112-n can also be used as fluid guides to control the working fluid flow at a preferred angle, so as to maximize torque generation.

Fluid guides 114-1 to 114-m guide the working fluid in a preferred angle towards the fluid guides 112 to achieve a preferred rotational force. Fluid guides 114-1 to 114-m may be formed as support structure to provide support between top plate 101a and separator structure 105. Fluid guides 114-1 and 114-m may be used to accommodate the design of fluid guides 112. Fluid guides 114-1 and 114-m may have thermal properties such that providing extra heating surfaces or cooling surfaces for heat transfer. Fluid guides 114-1 and 114-m may also form passages for working fluid circulation or use to control working fluid pressure. Fluid guides 114-1 and 114-m may be used as an access for heat or cold source outside engine chamber. Thus the heat engine design provides a method for adjusting working fluid temperature inside housing 101, by running fluid from a cooling source or a heating source through fluid guides to the hot zone, the cold zone or both. This also provides methods to adjust power output of the engine without changing heat source or heat sink. Fluid guides 114-1 to 114-m may enhance the movement of the working fluid, provide working fluid volume shaping, or other fluid characteristics that change within the working fluid path. Such characteristics, for example, may include working fluid velocity, direction, and volume. Although not shown in this embodiment, a similar fluid guide structure with corresponding sets of fluid guides may also be provided in cold zone 110b to shape the return path of the working fluid. Alternatively, the fluid guide structure in cold zone 110b may be provided in a different configuration (e.g., a different material, differently shaped fluid guides, performing different functions) to achieve different design objectives. Fluid guide 114-1 to 114-m may be shaped and used as blades to help the turbine structure creating torque for housing 101 to rotate in a predetermined direction. Fluid guide 114-1 to 114-m may be placed anywhere within chamber 110, depending on application requirements. Fluid guide structure 106 may be considered as part of the turbine structure.

According to another embodiment, fluid shapers may be used within a working fluid path to guide fluid or control fluid volume. Fluid shapers may include, for example, cones, bells and funnels. Fluid shapers may be solid or hollow. Fluid shapers may locate on or built into the interior walls of housing 101. Fluid shapers may be implemented at the transition space between two specific areas within the working fluid space, or at one or more positions within a specific area of the working fluid path. Examples of the working fluid space may include, for example, hot zone 110a, cold zone 110b, central open shaft 113 and space 121. An example of using a solid cone-shape fluid shaper is shown in FIG. 1 and FIG. 2. There, disk 108 has a portion which extends toward central open shaft 113 and forms a cone-shape fluid shaper 200 within housing 101. Also, fluid shaper 200 may be located between cold zone 110b and space 507 and may be used to guide working fluid toward hot zone 110a and may assist in maintaining the direction of the fluid flow motion. Fluid shaper 200 may change the velocity of the working fluid by narrowing a portion of the fluid path. One example uses fluid shaper 200 to control the working fluid volume entering central open shaft 113 from cold zone 11b. The smaller the working fluid space between fluid shaper 200 and the opening of the central open shaft 113, the faster the working fluid flows. A funnel fluid block within central open shaft 113 with the smaller end toward hot zone 110a can increase working fluid velocity within. Fluid shaper 200 may be used where the working fluid exits central open shaft 113 or where the working fluid enters hot zone 110a so to reduce the working fluid volume and thereby providing acceleration of the working fluid. Fluid shapers may be provided in any suitable material, shape, or function to achieve different design objectives. Fluid shapers may have an aerodynamic design.

When a substantial temperature difference in temperature exists between hot zone 110a and cold zone 110b, a circulation of the working fluid, indicated by flow lines 122 in FIG. 1, is established. In this circulation, the working fluid flows in a circular motion and also radially outwards in hot zone 110a, enters cold zone 110b through space 121 (i.e., a downward spiral motion), flows in a circular motion and radially inwards into cold zone 110b and returns to hot zone 110a through open shaft 113 (i.e., in an upward spiral motion). As the hot working fluid moves in a circulation motion on its way toward cold zone 110b, it produces a low pressure or depression in the center of the cold zone into which cold working fluid may be drawn and updrafted in a circulation motion into the hot zone. The fluid flow in each zone is thus similar to the motion of fluid in a hurricane or cyclone (i.e., “cyclonic”). In the hot zone, the updraft draws the working fluid strongly from the cold zone spirals outwards to the peripheral as the working fluid is heated. In the periphery, the strong downdraft draws the working fluid into the cold zone, where it then spirals inward to the low pressure point, where it is pulled back into the hot zone.

The working fluid flow possesses vorticity and flows with vortices. The working flow exerts a continuous force and imparts momentum on the turbine structure. Since the working fluid circulation is a convective vertical circulation, the vorticity is nearly horizontal. The working fluid flow from cold zone 110b to hot zone 110a is a rotating updraft. Similarly, working fluid flow from hot zone 110a to cold zone 110b is a rotating downdraft. The momentum of the working fluid is continuously maintained during the engine cycle, where the hot working fluid meets the cold working fluid. The working fluid continuously heating, expanding, cooling and contracting in the respective zones during each engine cycle. Therefore, a complete engine cycle and a complete working fluid path are provided within chamber 110. During an engine cycle, the working fluid exerts a force on all fluid guides or blades of the turbine structure at the same time. Each guide or blade of the turbine structure contributes work at the same time. Therefore, fluid control structures such as nozzles and pipes, which are generally used in fluid driven system to direct the working fluid to a particular portion of the turbine so as to provide an impulse, are not necessary in a heat engine of the present invention.

As discussed above, the working fluid has vorticity and has a continuous momentum, resulting from the heating and cooling of the working fluid, and the rotational motion of the fluid guides or blades. The turbine structure is rotated by the movement of the working fluid and, in turn, drives the working fluid into a rotational motion.

In this engine design, the working fluid expansion and contraction result in a force being applied upon the turbine structure, thereby creating a torque. In each cycle, the working fluid is accelerated by the combined forces of the expanding hot working fluid, the vertical rotation downdraft that forces the working fluid to flow from hot zone 110a to cold zone 110b, the contracting working fluid in cold zone 110b, and the rotational uplift that forces the working fluid to flow from cold zone 110b to hot zone 110a. Therefore, under this environment, the longer the engine runs, the faster the working fluid circulates. The velocity of the working fluid at the end of a first cycle becomes the velocity of the working fluid at the beginning of a second cycle, and is increased throughout the second cycle. The working fluid velocity is increased by the kinetic energy, which is then converted by the heat engine into mechanical work. The working fluid velocity increases during both the expansion phase and the contraction phase of an engine cycle. The working fluid gains momentum from the fluid guides and the rotation of the blades. The shape of the blades or the fluid guides and the channels help rotate working fluid. The fluid guides can also be used to adjust the temperature of various portions of the engine—i.e., to reduce or to increase the temperature of the hot zone, or to reduce or to increase the temperature of the hot zone.

The rotational and radial outward flow of the working fluid in the hot zone, the downward movement into the cold zone, the rotational and radial inward flow of the working fluid in the cold zone, and the upward movement into the hot zone extends along the length of the updraft. The speed of the rotation or ‘twisting’ increases as the effective column diameter diminishes. The cold working fluid is carried more effectively through the space in the form of a spinning updraft. The high fluid velocities result from conservation of angular momentum. The engine design is based on continuously heating and cooling to move the working fluid, and to use the rotary turbine blades to rotate the working fluid (i.e. maintaining the momentum in the working fluid).

The heat engine of the present invention is reversible, in that the cold zone and the hot zone may be created by providing mechanical power. Along with the rotational motion of the housing 101 of engine 100, the engine may also be powered by wind or water. Thus, the heat engine of the present invention may be used in applications such as solar power, or be powered from the exhaust from a nuclear plant. Mechanical power may also be provided to rotate the engine, so as to create the hot zone and the cold zone inside the chamber. The hot zone may then be used to power other engines, and the cold zone may be used to cool, depending on the desired application. The engine is scalable to accommodate different output power requirements and may be used at places with significant temperature variations.

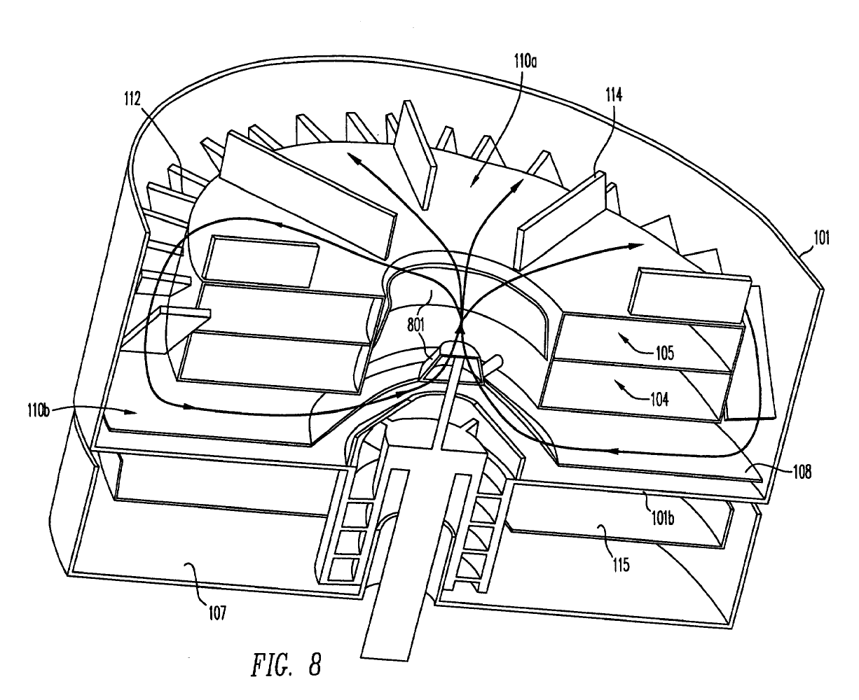

A heating mesh may be provided in hot zone 110b above the vicinity of open shaft 113, so as to increase the surface area over which the working fluid may be heated, thereby improving heating of working fluid efficiency. Heat may be concentrated and directed in hot zone 101a to the heating mesh. This heating mesh can also function as the contact point between external heat source and the heat reservoir 701 in separator structure 105. In this process, the relatively hot working fluid in hot zone 110a expands and flows into the cold zone 110b, where it is cooled and compressed. A one-way valve may be provided in open shaft 113 between hot zone 110a and cold zone 110b to prevent back flow of the working fluid from hot zone 110a into cold zone 110b. FIG. 8, which is a cross section view of heat engine 100, shows the working fluid circulation paths through fluid guide structure 106. As shown in FIG. 8, one-way valve 801 is provided in open shaft 113 between hot zone 110a and cold zone 110b to prevent back flow of the working fluid from hot zone 110a into cold zone 110b.

As can be seen from the above, the system of fluid guides in the embodiments described above may perform multiple tasks. For example, each fluid guide may be structurally attached to one or more walls of fluid guide structure 106, rotary structure 111, the passages between rotary structure and insulator layer 104, insulator layer 104 and separator structure 105. Each fluid guide in central open shaft 113 may be structurally adapted to one or more walls of the structures within. Multiple channels, passages or conduits for the working fluid flow within housing 101 (or chamber 110) are formed. These passages may be located within any portion of the working fluid path for different applications. These passages may be at an angle to the working fluid to assist the movement of the working fluid. One advantage of having fluid guides or blades to define passages for fluid flow between adjacent fluid guides is reducing turbulence in the working fluid. The structures of the fluid guides can be used to affect the mechanical parameters¹ of heat engine 100, such as the working fluid pressure and its angular velocity, the directions and angles the working fluid flow and the magnitude of the torque causing the rotary motion. The design of the fluid guides therefore improves the power output of heat engine 100. Alternately, the fluid guides need not attach to any rotary structure 111, insulator layer 104 and separator structure 105. In this instance, multiple channels, passages or conduits for the working fluid flow are not formed. The resulting design is simpler, has a more even heat distribution and a lighter housing. One example of a mechanical parameter can be angular velocity of rotation.

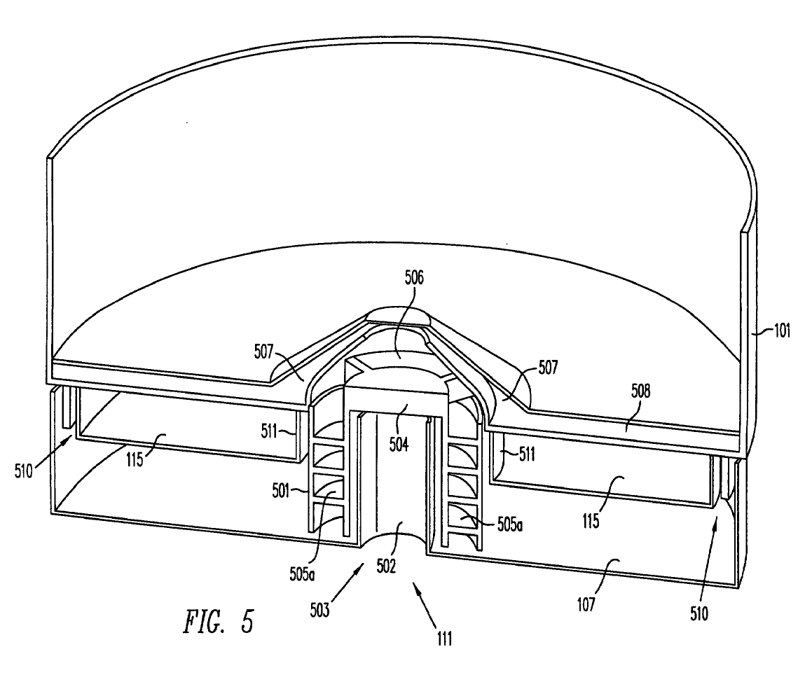

Rotary structure 111 is located in the lower portion of open shaft 113 and supports the weight of housing 101, including the various elements of heat engine 100 housed within housing 101. Rotary structure 111 rotates with axle 109 by receiving the combined torque transmitted from all turbine structures or fluid guide structures within housing 101. As mentioned above, the operating temperature difference between hot zone 110a and cold zone 110b may be maintained by a cooling fluid. In the embodiment shown in FIGS. 1, 2 and 3, the cooling fluid is provided from stationary cooling reservoir 107. In this embodiment, rotary structure 111 facilitates the cooling fluid uptake. FIG. 5 shows rotary structure 111 of FIGS. 1 and 2 in greater detail. As shown in FIG. 5, rotary structure 111 has cylindrical outer wall 501, a portion of which is inserted into cooling reservoir 107 through a center opening of reservoir cover 115 and surrounds cylindrical inner wall 502 of cooling reservoir 107. Cylindrical inner wall 502 of cooling reservoir 107 may extend up to top wall 504 of rotary structure 111. Axle 109 may be attached to top wall 504 of rotary structure 111. Rotary structure 111 also serves to reinforce bottom plate 101b of housing 101 to allow it to bear the load of housing 101 and its included elements of heat engine 100. Axle 109 is designed to support rotary structure 111 and to transmit the rotary motion of housing 101 to the load being driven. Rotary structure 111 includes threaded passage 505a which opens into cooling reservoir 107. As rotary structure 111 rotates, it draws the cooling fluid up threaded passage 505a into a chamber 506, where the cooling fluid flows into space 507, which distribute the cooling fluid into spiral passages 601 and 602 (FIG. 3) provided in the bottom portion of insulator layer 104. The cooling fluid may also overflow into space 507, where it is guided into passages within space 508 which is located between bottom plate 101b of housing 101 and disk 108 at the bottom side of cold zone 110b. Both the spiral passages in insulator layer 104 and the passages space 508 under disk 108 returns the cooling fluid to cooling reservoir 107 through an outlet at cooling fluid capture 510. Support elements, such as post, walls or beams may be provided within space 508 to provide support and to channel fluid flow in any desired manner. Cooling fluid capture 510 may include an enclosed conduit for channeling the cooling fluid through reservoir cover 115. As housing 101 rotates, the cooling fluid is circulated to maintain the temperature of cold zone 110b without an external pump.

The structure of the cooling system, according to the embodiment shown in FIG. 5, therefore includes rotary structure 111, cooling reservoir 107, reservoir cover 115, cooling fluid capture 510, and heat sinks (not shown) which may be provided to dissipate heat from cooling reservoir 107. Cooling reservoir 107, reservoir cover 115 and cooling fluid capture 510 are stationary and can be supported by an external structure (not shown). Bearings may be provided where contact is made between housing 101 and the walls of cooling reservoir 107. For example, bearings maybe provided between bottom plate 101b of housing 101 and the side walls of cooling fluid capture 510, between cylindrical outer wall 501 and cylindrical wall 511 of reservoir cover 115, between top wall 504 of rotary structure 111 and cylindrical inner wall of 502 of cooling reservoir 107, and between cylindrical inner wall 502 of cooling reservoir 107 and the walls of recess 503 of rotary structure 111. The bearings may also be used mechanically support the weight of heat engine 100 and to provide stability during rotation. The bearings and the reservoir cover 115 prevent cooling fluid spill. Of course, an external structure, other than cooling reservoir 107, may be provided to mechanically support housing 101. In this embodiment of present invention, cooling fluid capture 510 may be enclosed by bearings. Other configurations for cooling fluid capture 510 are possible.

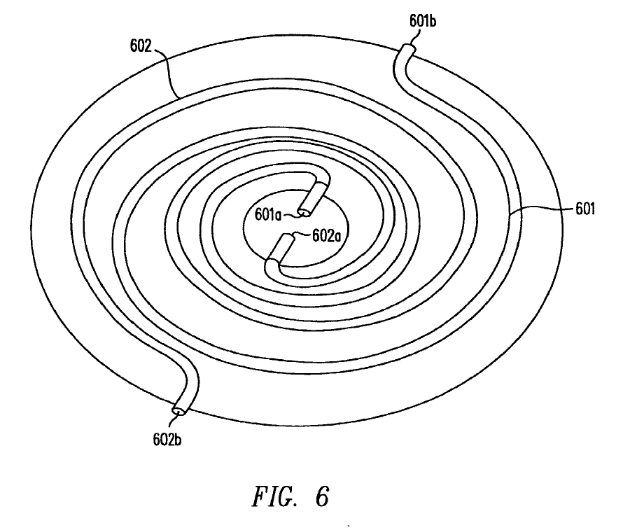

Insulator layer 104 may be filled with a thermally insulating material. A portion of the cooling system is structurally adapted to the insulator layer 104. FIG. 6 is a top view showing spiral passages 601 and 602 for cooling fluid in the portion of insulator layer 104 abutting cold zone 110b, according to one embodiment of the present invention. (Although only two passages are shown in FIG. 6, a practical implementation may have additional passages, depending on the cooling fluid flow rate desired, as discussed below). FIG. 6 shows the cooling fluid entering passages 601 and 602 at opening 601a and 602a, respectively, and passing into conduits at outlets 601b and 602b to return to cooling fluid capture 510 through passages within fluid guide structure 106 or through support structures in cold zone 110b. To achieve effective cooling in cold zone 11b, passages for cooling fluid may be provided between disk 108 and a fluid guide structure, dedicated conduits, passages along or embedded in the support structure, or a combination of structures in cold zone 110b. Generally, from threaded passage 501, the cooling fluid may flow radially towards the periphery and pass into cooling fluid capture 510. Many other schemes of distributing the cooling fluid throughout cold zone 110b are possible. According to one embodiment, support structures may be provided throughout insulator layer 104 for mechanical support to insulator layer 104.

The cooling fluid is preferably a fluid having a specific heat capacity much greater than the specific heat capacity of the working fluid. To maintain cold zone 110b at the preferred temperature, heat in the working fluid flowing into cold zone 110b must be dissipated by the cooling fluid and by housing 101. Efficiency of heat dissipation within housing 101 depends, for example, by the ability of fluid guides and blades of fluid guide structure 106 in cold zone 110b to conduct heat away from the working fluid they are in contact to housing 101. The heat in the working fluid in excess of the heat dissipated by housing 101 is dissipated by the cooling fluid. The angular speed at which the cylindrical enclosure rotates determines the pressure at which the cooling fluid is drawn into threaded passage 505a of rotary structure 111 and, thus the volume of the cooling fluid flowing into cold zone 110b. At higher energy input, the cylindrical enclosure rotates at a higher angular speed, thereby drawing a greater volume of cooling fluid per unit time, thus resulting in a greater cooling effect to maintain heat engine 100 within the desired operating temperature range. The lengths and the distribution of passages surrounding cold zone 110b depend on the volume of the cooling fluid required per unit time and the ability of cooling reservoir 107 to transfer the heat in the cooling fluid to the environment. If the passages are long, or if the volume of the cooling fluid flowing through the passages per unit time is low, the temperature difference between the cooling fluid in cooling reservoir 107 and the returning cooling fluid will be higher. Conversely, if the lengths of the passages are short, or if the volume of the cooling fluid flowing through the passages per unit time is high, the temperature difference between the cooling fluid in cooling reservoir 107 and the returning cooling fluid will be lesser. The lesser temperature difference is preferred. Conventional heat sinks may be provided on the outer wall of cooling reservoir 107 to dissipate the excess heat.

An optional heat reservoir 701 may be provided at separator structure 105. Such a heat reservoir minimizes the fluctuation of power output even though the amount of heat provided by the heat source may fluctuate during the engine cycles. Heat reservoir 701 may be used to accommodate the variations in power demand. That is, heat reservoir 701 may supplement insufficient energy production during times of high demand, and stores power at times when production exceeds demand. Heat reservoir 701 also can retain heat and acts as another heat source for heating up the working fluid after the primary heat source is no longer available or does not provide sufficient thermal energy. Heat reservoir 701 may couple with a primary heat source to increase the heating volume or heating efficiency of the hot zone. Heat storage media for heat reservoir 701 may be phase change materials or materials transforming the stored energy to higher temperatures by dissociation or recombination reactions. The materials that transform the stored energy to lower temperatures by dissociation or recombination reactions may be used in insulator layer 104 or cold zone 110b for cooling purposes. In one embodiment, a phase change material is used to increase the thermal energy density of heat reservoir 701 and to improve the power performance at a constant temperature.

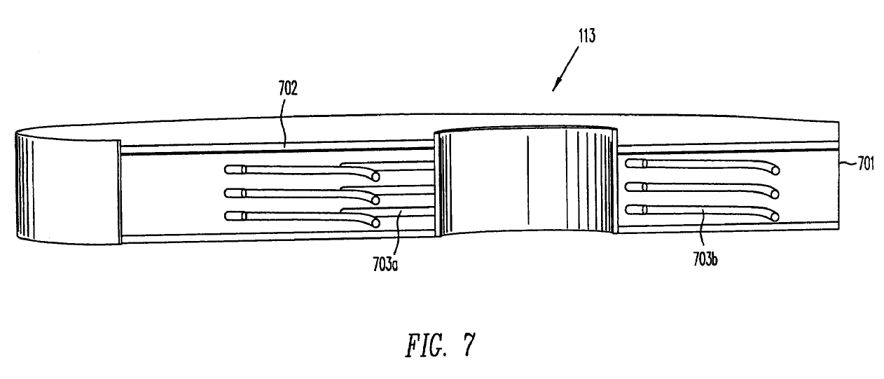

FIG. 7 shows a cross section view of heat reservoir 701, in accordance with one embodiment of the present invention. As shown in FIG. 7, heat reservoir 701 includes a cavity filled with a fluid of high specific heat capacity or thermal storage density, and metallic plate 702 supported by springs 703a and 703b. The fluid in heat reservoir 701 may be pressurized, and should preferably remain liquid throughout the entire range of operating temperatures of heat engine 100. (Although only two springs are shown in FIG. 7, any number of springs may be used to support metallic plate 702.) Metal support structures (not shown) may be provided throughout heat reservoir 701 to both support the top and bottom walls of heat reservoir 701 and to conduct heat from hot zone 110a. Initially, the fluid in heat reservoir 701 is cold, and metallic plate 702 is not in contact with the bottom portion of hot zone 110a. As heat engine 100 operates, the temperature of the fluid in heat reservoir 701 rises. As a result, springs 703a and 703b expand to allow metallic plate 702 to contact the floor of hot zone 110a for greater surface area for heat transfer between hot zone 110a and the fluid in heat reservoir 701. According to one embodiment of the present invention, solid state materials or mixture of different types of materials can be used in heat reservoir 701. A heating mesh may also be used to facilitate heat transfer. Fluid guides may be used to provide an external heat source passages to increase heat transfer to hot zone 110a and heat reservoir 701. In such design, a set of heat pipes or heating fluid may be directed through the fluid guides. The working fluid in the heat pipes may enter a first fluid guide from outside housing 101 and passes into heat reservoir 701 and returns back to outside housing through a passage within a second fluid guide in hot zone 110a. Thus, hot zone 110a may be surrounded with heating elements to provide heat efficiency.

A heat source may contact housing 101 in a center area or an annular area, depending on the desired application. When the position of hot zone 110a and cold zone 110b are reversed, the cooling system structure and heating sources may form a different operating configuration. This may provide advantages in circulating working fluid and maintaining a larger temperature difference between the hot zone and the cold zone.

The above detailed description is provided to illustrate the specific embodiments of the present invention and is not intended to be limiting. Numerous modifications and variations with in the scope of the present invention are possible. The present invention is set forth in the following claims.

We claim:

1. A heat engine, comprising:
a housing including a chamber having a first zone and a second zone bathed in a working fluid circulating between the first zone and the second zone wherein, during operation of the heat engine, the first zone and the second zone has a temperature difference; and
a turbine having a plurality of surfaces in the fluid paths of the chamber, and wherein a first portion of the turbine is located in the chamber, such that the motion of the working fluid over the plurality of surfaces drives the turbine in a rotational motion.

2. A heat engine as in claim 1, wherein the first portion of turbine located between the first zone and the second zone.

3. A heat engine as in claim 1, wherein the first portion of turbine is structurally adapted to the chamber and drives the housing in motion.

4. A heat engine as in claim 1, wherein the first portion of turbine forms multiple passages defined by structures attached to said housing for circulating the working fluid.

5. A heat engine as in claim 1, wherein the turbine comprises a second set of blades providing access to a heat source or a cold source outside the chamber.

6. A heat engine as in claim 1, further comprises a cooling system includes a rotary portion having a threaded passage such that the rotational motion of the turbine causes the rotary structure to draw a cooling fluid into the engine.

7. A heat engine as in claim 1, further comprising a heat storage structure within the chamber providing a second thermal energy source to the working fluid during the engine's operation.

8. A method for providing a heat engine, comprising:
providing a housing including a chamber having a first zone and a second zone bathed in a working fluid circulating between the first zone and the second zone wherein, during operation of the heat engine, the first zone and the second zone has a temperature difference; and
providing a turbine having a plurality of surfaces in the fluid paths of the chamber, and wherein a first portion of the turbine is located in the chamber, such that the motion of the working fluid over the plurality of surfaces drives the turbine in a rotational motion.

9. A method as in claim 8, wherein providing the first portion of turbine is located between the first zone and the second zone.

10. A method as in claim 8, wherein providing the first portion of turbine is structurally adapted to the chamber and drives the housing in motion.

11. A method as in claim 8, wherein providing the first portion of turbine forms multiple passages defined by structures attached to said housing for circulating the working fluid.

12. A method as in claim 8, wherein providing the turbine comprises a second set of blades provide access to a heat source or a cold source outside the chamber.

13. A method as in claim 8, further comprising providing a cooling system includes a rotary portion having a threaded passage such that the rotational motion of the turbine causes the rotary structure to draw a cooling fluid into the engine.

14. A method as in claim 8, further comprising providing a heat storage structure within the chamber providing heat to the working fluid during the engine's operation.

15. A heat engine, comprising:
a housing including a chamber containing a working fluid and having a first zone and a second zone maintained at a temperature difference; and
a first thermal structure within the chamber that transfers heat to;
a second thermal structure adapted to maintain the temperature difference.

16. A heat engine as in claim 15, wherein the first thermal structure performs heat transfer between the first thermal storage structure and an external heat source through a conductive passage.

17. A heat engine as in claim 15, wherein the first thermal structure comprises a heat storage device.

18. A method for providing a heat engine, comprising:
providing a housing including a chamber containing a working fluid and having a first zone and a second zone maintained at a temperature difference; and
providing a first thermal structure within the chamber that transfers heat to;
providing a second thermal structure adapted to maintain the temperature difference.

19. A method as in claim 18, wherein providing the first thermal structure performs heat transfer between the first thermal storage structure and an external heat source through a conductive passage.

20. A heat engine, comprising:
a housing enclosing a chamber having a first zone and a second zone with temperature difference bathed in a working fluid circulating unimpeded between the first zone and the second zone; and
a plurality of structures which are attached to the portion of the housing exposed to the chamber, the area having surfaces in contact with the working fluid, and wherein some of the structures are located in the chamber to cause the working fluid to flow in a cyclonic path.

21. A heat engine as in claim 20, wherein a draft enhance the working fluid velocity from the first zone into the second zone.

22. A heat engine as in claim 20, wherein the momentum of the working fluid returning back to the first zone in one cycle increases the momentum of the working fluid in the next cycle.

23. A method for providing a heat engine, comprising:
providing a housing enclosing a chamber having a first zone and a second zone with temperature difference bathed in a working fluid circulating unimpeded between the first zone and the second zone; and
providing a plurality of structures which are attached to the portion of the housing exposed to the chamber, the area having surfaces in contact with the working fluid, and wherein some of the structures are located in the chamber to cause the working fluid to flow in a cyclonic path.

24. A method as in claim 23, wherein providing a draft to enhance the working fluid velocity from the first zone into the second zone.

25. A method as in claim 23, wherein providing the momentum of the working fluid returning back to the first zone in one cycle increases the momentum of the working fluid in the next cycle.

26. A rotating heat engine having a fluid-based heat exchanger, comprising:
a fluid reservoir; and
a structure including threaded passages for fluid flow, the structure being structurally adapted to a housing of the rotating engine such that the rotational motion of the rotating engine determines the speed of fluid flow from the fluid reservoir.

27. A method for providing a fluid-based heat exchanger for a rotating heat engine, comprising:
providing a fluid reservoir; and
providing a structure including threaded passages for fluid flow, the structure being structurally adapted to a housing of the rotating engine such that the rotational motion of the rotating engine determines the speed of fluid flow from the fluid reservoir.
